(19) United States
(12) Patent Application Publication
(10) Pub. No.: US 2022/0052980 A1
(43) Pub. Date: Feb. 17, 2022

(54) METHOD OF SERVICE IDENTIFICATION IN ENUM STRUCTURE

(71) Applicants: Oleksiy PTASHNIY, Kharkiv (UA); Yurii KARGAPOLOV, Odesa (UA); Yurii HONCHARUK, Kyiv (UA); Oleksiy MYKHAYLOV, Maple Ridge (CA)

(72) Inventors: Oleksiy PTASHNIY, Kharkiv (UA); Yurii KARGAPOLOV, Odesa (UA); Yurii HONCHARUK, Kyiv (UA); Oleksiy MYKHAYLOV, Maple Ridge (CA)

(21) Appl. No.: 17/399,480

(22) Filed: Aug. 11, 2021

(30) Foreign Application Priority Data
Aug. 13, 2020 (UA) U 2020 05243

(51) Int. Cl. H04L 29/12

(52) U.S. Cl. CPC H04L 61/1511

(57) ABSTRACT

The claimed technical solution is used in the field of electronic communications, namely it refers to methods of identification and receipt of information about the service on the basis of requests made through electronic communications networks. In particular, this technical solution applies to the E.164 NUmber Mapping system (ENUM) and the possibility of using in this system the services defined in the resource records of domain names in ENUM, if such services are not known in advance according to IANA Enumservice Registrations. It is proposed to create a service registry, which must meet the following conditions: each service has at least one original, unique identifier and mapped to this identifier internet addresses and metadata for service processing. Using this unique identifier, the Internet addresses and metadata for the corresponding service are retrieved from the service registry based on the corresponding request.

### CROSS-REFERENCE TO RELATED PATENT APPLICATIONS

This patent application claims priority to Ukranian patent application u 2020 05243 filed Aug. 13, 2020, which is fully incorporated herein by reference.

### TECHNICAL FIELD

The claimed technical solution relates to the field of electronic communications, in particular to methods of identification and receipt of information about the service on the basis of requests made via telecommunications networks.

### BACKGROUND

The system of mapping telephone numbers E.164 ENUM (E.164 NUmber Mapping) is known from the prior art, according to the protocols of said system it is possible to integrate E.164 phone numbering system with Internet addressing system. ENUM is guided by the priority and algorithms of using the domain name system (DNS) to store and retrieve information about resources according to the phone number that is mapped to the domain name with a set of resource records (NAPTR) about predefined and known in advance types of services in the form of Internet addresses, rules and parameters of their processing, for example:

### VoIP,

IP fax servers,
Voicemail servers,
Services of PSTN (redirection),
and others identified in the relevant static depository, which is informatively posted on the IANA Enumservice Registrations page.

The initial and most commonly used ENUM scenario is configuring rules for redirection between the telephone network and VoIP Internet telephony systems. For example, if the phone number has different profiles, you can use ENUM to automatically change the method and location of reception by redirecting the call depending on the type of network the Receiving Party is in (Called Party according to ITU Recommendation Q.731) (automatic switching between mobile phone and VoIP for the most convenient or less expensive way to terminate the call) or depending on the time of day, for example, if call redirection during the lunch break is performed.

ENUM can also map a phone number to an email address, web address, or a different service, defined in the depository mentioned above.

From the prior art Russian patent No. 2483352 is known, which discloses a method of identifying a service, including the steps of receiving a service request, including the address of a unified resource locator and a field for specifying the type of service content.

Method, device and system for service identification described in the patent of the Russian Federation No. 2483352 provides for the presence of an element in the form of a gateway device of the wireless application protocol (WAP GW) in the system architecture. The WAP GW functions as a pre-configured device for receiving a multimedia message service request (MMS), which includes a field for specifying the type of service content from the service request transmitted by the terminal and the service request resolving device. When the service gateway address (APN) is configured incorrectly, so that the request cannot be processed on the device, the service type is identified from the service request according to the field included in the service request. Requesting the address directly to the MMS service specified in the request is performed by contacting the ENUM server, which contains the address of the home MMSC of the sender, retrieves and returns it to WAP GW. WAP GW sends a response to the request to the user's terminal, which now has the ability to contact the service directly using the address obtained.

The disadvantage of this solution is the use of a gateway (WAP GW), the task of which is to initiate a request to the ENUM server in the event of an incorrectly formed address of the service gateway within the service request. This implies that an integral requirement for service identification is the need to have the address of the service to execute the request. This imposes additional conditions on the service identification process. Another disadvantage is that the existing solution is exclusively about communication services.

### SUMMARY

The task of the claimed technical solution is to create a more universal method of service identification, which can be used for any type of service, including non-communication, and which does not require a gateway (WAP GW), and in which there is no need to know the service address in advance. An additional task for the claimed technical solution is to identify the address of the service, if the type of service and subscriber's telephone number are previously known.

This problem is solved due to the fact that the method of identifying the service includes the stages at which:

form a request for information about the service,
according to the technical solution,
pre-create a service registry, in which by means of the first network tool pre-enter at least one entry that characterizes the properties of the service, and besides the service registry is made with the ability to change, add and delete an entry that characterizes the properties of the service,
then by means of the second network tool, enter, at least one resource record into the DNS zone of ENUM domain associated with the telephone number that contains the type of the service, reference to the service registry, service identifier in the registry, service parameters for generating further request to the service registry, convert the phone number into the ENUM domain name using the method defined for ENUM,
then using the third network tool generate a DNS query to obtain resource records for said ENUM domain name using DNS tools,
at least one resource record associated with the specified ENUM domain name telephone number is sent from the DNS server to the third network tool in response to the DNS query,
determine from at least one resource record information about the service identifier, type of the service, reference to the service registry, parameters of the service for further formation of the request to the service registry,
using the third network tool form and perform request to the service registry, which at the minimum contains the identifier of the service,
in response to the request to the service registry, information regarding the network address and metadata of the service are sent to the third network tool from the service registry.

The technical result that is achieved by implementing the claimed method is providing the ability to obtain a network address and metadata for at least one service associated with the subscriber's phone number. This information is selected from the service registry that stores service metadata. The service registry is able to store information about services of any type, not limited to the IANA Enumservice Registrations list. The reference to the service registry and the service identifier are stored in the ENUM resource records of the subscriber's domain. Metadata returned by the service registry is machine-readable. This technical result was obtained for the first time.

Another new technical property is the extension of the functional properties of the method by applying it to non-communication services, which significantly expands the possibilities of its use.

### BRIEF DESCRIPTION OF THE DRAWINGS

The claimed method is illustrated by the accompanying drawings, which in no way limit the embodiments and applications of the claimed method, but are given to explain the essence of the technical solution.

FIG. 1 demonstrates the system architecture of a typical service identification process in the ENUM structure by the subscriber's telephone number and the use of the identified service.

FIG. 2 shows the diagram of the organization of requests and data flows of the method.

FIG. 3 demonstrates the diagram of an example of the use of ENUM to obtain medical data of the subscriber of the telephone number when performing rescue services in case of emergencies.

FIG. 4 shows the diagram of an example of the use of ENUM to obtain technical information about the vehicle during vehicle maintenance.

### DETAILED DESCRIPTION OF THE PREFERRED EMBODIMENT

The following is a detailed description of the claimed method with reference to the accompanying drawings and its main embodiments. This description is intended to explain the essence of the claimed method and is not intended to limit any implementation.

For a clearer and more unambiguous understanding of the essence of the claimed method, the following is a thesaurus of concepts used.

The first network tool is a network technical solution for mostly remote work on the server.

The second network tool is a network technical solution that can be used to edit the DNS zone.

The third network tool is the user's terminal, which receives information from the DNS and service registry.

Subscriber's telephone number (telephone number of a subscriber) is a telephone number specified according to the E.164 standard.

Metadata—structured information that characterizes the objects that are available or are expected in the information environment such as service profiles, protocols and rules of access to the information provided by services, rules for provision of services, resources, information data, etc.

Service—software and hardware system (a set of telecommunication and non-telecommunication services, associated with software and hardware systems), which provides dialog data exchange to the user, has a unique network address (or multiple network addresses) and which interacts with other third-party applications by exchanging data upon the request of the user. The meaning of the concept of “service” by this definition is broader compared to similar concept in the above patent of the Russian Federation No. 2483352, but does not contradict it.

Service registry—information and telecommunication software and hardware system that stores and publishes information about services, such as, for example (non-exclusively) network addresses responsible for processing service requests, protocols and rules for processing requests (parameters of requests, receiving responses, processing them) of this service, requirements for authentication and authorization, other metadata. Services in the service registry must always have a unique identifier that can be used to request information about this service.

Telephone number subscriber—a person or device which is assigned the specified phone number in the E.164 format.

Resource record—a record that specifies correspondence of the name and service information in the domain name system (DNS).

DNS server—a software and hardware solution to enable the functioning of a hierarchical system of domain names in accordance with Internet standards.

In the current state of the art the types of services must be known in advance and must be predefined in the IANA Enumservice Registrations depository. Data in the said depository is not designated for automatic reading, but only for static enumeration of a set of available types of services.

According to the claimed technical solution, it is proposed to create a service registry that must meet the following conditions: each service has at least one original (non-repeated) unique identifier. Using this unique identifier, the service registry searches for and retrieves network addresses and metadata of the relevant service.

The types of services stored in the service registry can be both telecommunication and non-telecommunication.

The service registry stores data blocks, in particular regarding:
(1) properties of the service, including data regarding (1.1) service name, (1.2) network addresses of the service (1.3) protocol for the service, (1.4) general description of the service,
(2) functionality and conditions of service implementation, including data regarding (2.1) telecommunication protocols used by the service, (2.2) industry protocols used by the service, (2.3) a formalized description of the structure of services included in the service, (2.4) minimum set of parameters required to perform the service which correlates to (2.3), (2.5) the complete set of parameters required to perform the service which correlates to (2.3), (2.6) the minimum and maximum allowed limit values of parameters to perform the service,
(3) service access schemes, including data regarding (3.1) the formalized sequence of actions for accessing the service, (3.2) the relevant set of parameters for authentication, authorization and verification procedures when accessing the service,
(4) security requirements for using the service, that include data regarding (4.1) the list of certification centers that may issue certificates for use with the service, (4.2) validity intervals for the certificates used,
(5) the formats of input and output parameters of the service, including data regarding (5.1) the specification of the output data required to perform the service, which correlates with (2.4) and (2.5), (5.2) specification of input data for each service that correlates with (2.3),
   and provides, upon request, information about the services, such as, for example, the network addresses at which the service resources are located, the protocols using which the service operates, the service's requirements for authentication, authorization and verification procedures, and other service metadata.

This list is not exhaustive and does not contain mandatory data blocks.

The services in the service registry have a unique identifier that can be used to request information about the service.

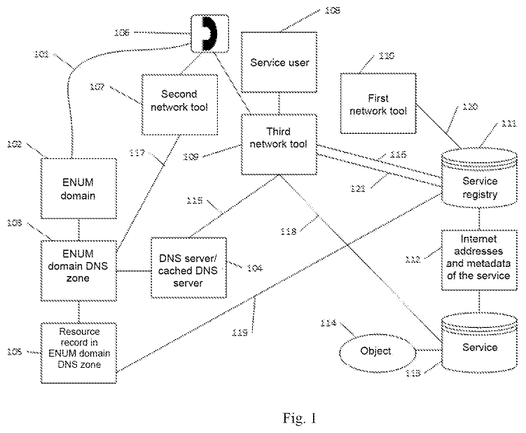

The claimed solution is illustrated by the architecture shown on FIG. 1. The DNS standard defines several types of resource records 105 (A, AAAA, TXT, MX, NAPTR and others). Any number of records 105 of any of these types may be specified for the domain name 102. In general, resource records 105 are created and edited using the second network tool 107. The list of resource records 105 and their structure can be changed using the second network tool 107.

The DNS zone 103 of the domain 102 is served by at least one DNS server 104 that responds to DNS queries 115 from Internet users by selecting the appropriate records 105 from the DNS zone 103.

In the prior art, the resource records 105 contain a direct reference to the service 113. In the claimed solution, the resource records 105 do not store direct references to the service 113, but the resource record 105 contains the type of service, reference to the service registry 111, service ID and other information that, for example, identifies the object 114 in the service 113, and also personalizes the conditions of use of service 113.

According to the claimed method, a service registry 111 is pre-created, in which by means of the first network tool 110 at least one entry [about service 113] is added 120, which characterizes the properties of the service 113. The service registry 111 is created with a capability to change, add or delete entries that characterize the properties of services 113.

By means of the second network tool 107, at least one resource record 105 containing the service type, reference 119 to the service registry 111, service ID, service parameters for further formation of request to the service registry 111, for example the identifier of telephone number subscriber 106 in the service 113, is entered 117 into the DNS zone 103 of the ENUM domain 102 associated 101 with the telephone number 106.

Knowing the telephone number 106, customer of service 108 using the third network tool 109, in the standard ENUM way, converts this number into the ENUM domain name 102 associated 101 with it. For the domain name 102 obtained as a result of the conversion, a DNS request 115 is sent by the customer of service 108 via the third network tool 109 to obtain resource records 105 of the DNS zone 103 of the domain 102 to the DNS server 104, which serves this domain name 102 or is a caching DNS server. In response to request 115, the DNS server 104 returns a list of resource records 105 related to this domain name 102. The number of resource records 105 returned by the DNS server 104 may be more than one.

Having received using the third network tool 109 a list of resource records 105, the customer of service 108 with the help of the third network tool 109 selects from the list those resource records 105 that contain an indication of the desired type of service that the customer of services 108 wishes to use.

Resource records 105 may contain any additional information (for example, about parameters that describe the place and time of use of the service), which are additional filters for selecting the desired resource records 105.

At least one resource record 105 is selected, from the contents of which the following information is taken: information about the type of service, links 119 to the service registry 111, the service identifier 113 in the service registry 111, and other information, which, for example, identifies object 114 for the service 113, and also personalizes the terms of use of service 113. Based on this data, a request is generated and the third network tool 109 sends the request 116 to the service registry 111 in order to obtain Internet addresses and metadata of the service 112.

Service registry 111, having received a request 116, which contains the service ID, returns 121 metadata and the Internet addresses of the service 112 to the third network tool 109 to the customer of service 108.

The customer of service 108, using the received Internet addresses and metadata 112, using the third network tool 109 accesses 118 the service 113, to obtain the desired service or information.

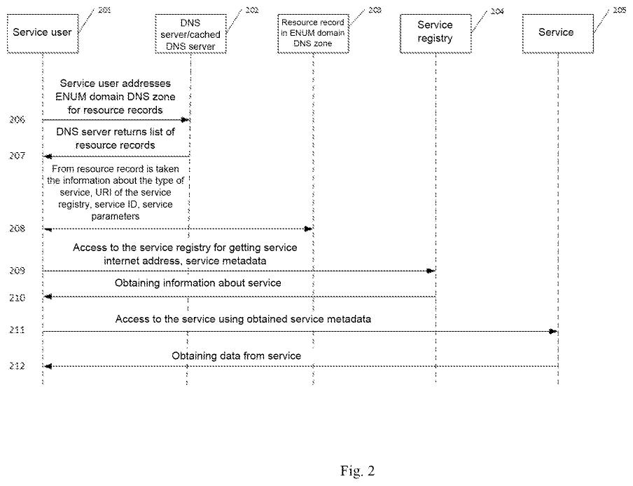

FIG. 2 shows a diagram of the organization of requests and data flows of the method of identifying the service under the condition of creating the architecture shown in FIG. 1.

The service user 201 queries 206 the DNS server or caching DNS server 202 serving the DNS zone of the ENUM domain 103 to obtain resource records 203. It should be noted that the user of the service 201 performs actions using the third network tool 109. A specialist must understand that the DNS zone of ENUM domain 103 is served by at least one DNS server 202.

DNS server 202 based on the information available in the DNS zone of the ENUM domain 103 determines the list of resource records 203 and returns 207 it to the service user 201.

From the resource record 203 the information about the type of service, URI of the service registry, service ID and service parameters is obtained 208. Based on this received data, a request 209 to the service registry 204 is performed in order to obtain data on service internet addresses and service metadata. The service registry 204, based on the received request 209, sends the response 210 to the third network tool 109, which is used by the user 201, which contains this information about the service.

After that the user of service 201 using the third network tool 109 performs access to service 211, using the received metadata of the service. In response, the user 201 through the third network tool 109 receives 212 the result of the service work.

The following are examples of implementation of the claimed object. These examples are intended to prove the applicability of the method. However, these examples do not limit the use of the claimed object. Specialists in the field of telecommunications or information technologies should be able to understand the principles of building a protocol of interaction between the user's terminal and servers to implement the claimed function.

Example 1 Use of ENUM to obtain medical data of a telephone number subscriber who is the registrant of the corresponding ENUM-domain when performing the emergency rescue services (as an example, the “MED” service type is created).

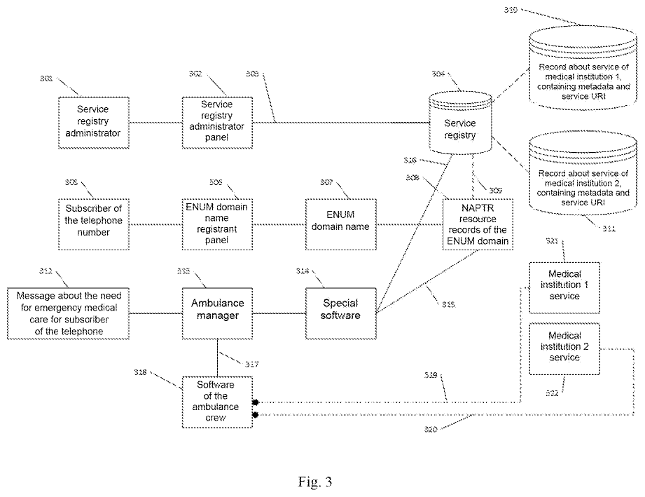

The example is illustrated with FIG. 3 that demonstrates a diagram of using ENUM to obtain medical data of the telephone number subscriber when performing the emergency rescue services.

Previously, for example, the service registry administrator 301 by means of software application, for example, by using the administrator panel 302 enters 303 records of services 310, 311, which contain information necessary for rescue services and which characterize the properties of the services, into the service registry 304. These services are provided by two relevant medical institutions.

The service registry administrator panel 302 is implemented with the ability to change, add or delete entries that characterize the properties of the services. An example of a service belonging to the rescue services can be medical institutions that provide signaling information about the subscriber's health upon authorized request. Example of signaling information: blood type, sensitivity to drugs, etc., i.e. information that indicates what restrictions should be observed when providing medical care. It should be understood that the databases of the respective medical institutions that provide services 321, 322 store signal medical information about the subscriber of the telephone number 305. These medical records were obtained as a result of observations, clinical examinations and other medical procedures on the telephone number subscriber in these medical institutions.

Previously, the telephone number subscriber 305 using standard tools for working with domain names, for example, the registrant panel 306 must register the ENUM domain name 307, which corresponds to the subscriber's telephone number,

In the DNS zone of the ENUM domain, NAPTR resource records 308 are created using the DNS zone tools, such as the registrant panel 306. Each such record contains the service type “MED”, the service identifier, the reference 309 to the service registry 304 and the identifier of the telephone number subscriber in the service database. Each of these resource records corresponds to one medical institution where the subscriber is served. Thus, each of the medical institutions is a service that, upon authorized request, provides signal medical information that is known to the institution.

If there is a need to provide emergency assistance to a telephone number subscriber, for example, when receiving a message 312 about the need for emergency medical care, knowing the telephone number of the subscriber, the ambulance manager 313 using special software 314, accesses 315 the DNS zone ENUM domain of the subscriber 305, finds there all resource records containing the service type “MED” 308, obtains service identifiers and reference 309 to the service registry 304 from these records, performs request to the service registry 304 and receives 316 metadata 310, 311 of servers of medical institutions 321, 322, including URI, which can be used to access the signal medical information about the subscriber using the identifier of telephone number subscriber in the databases of services, which are also contained in the resource records of the ENUM domain 308.

Next, the obtained data is transmitted 317 to the software of the ambulance crew 318, which in turn by means of authorized requests 319, 320 to the corresponding services 321, 322 receives signal medical information about the subscriber of the telephone number.

Thus, access to medical signaling information (which can be processed automatically) in the event of an emergency is made much easier, which reduces the likelihood of medical errors during the provision of emergency care.

Example 2. Use of ENUM to obtain technical information about the vehicle during vehicle maintenance (the “VEHICLE” service type is created as an example)

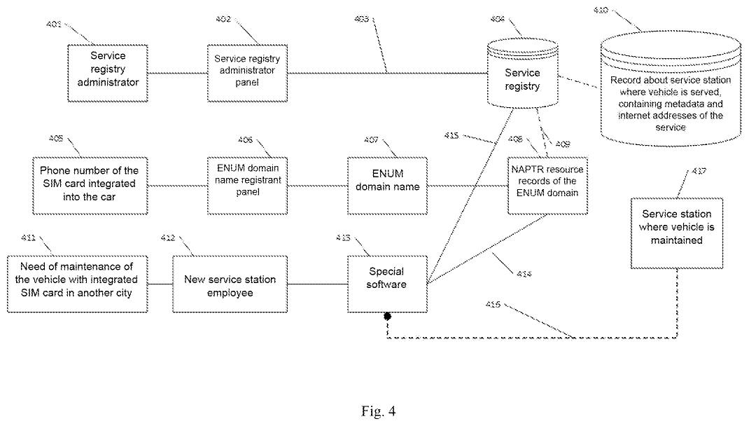

An example is illustrated with FIG. 4, which shows a diagram of an example of the use of ENUM to obtain technical information about the vehicle during maintenance of the vehicle.

Previously, for example, the service registry administrator 401 by means of software, such as the service registry administrator panel 402, enters 403 records 410 about the service 417, which functionally belong to the services that perform vehicle maintenance and which characterizes the properties of service, to the service registry 404. The service registry administrator panel 402 is implemented with capability to modify, add, or delete entries similar to 410 that characterize the properties of the services. An example of a service belonging to the services that perform vehicle maintenance is a vehicle maintenance station (VMS), which upon authorized request provides available technical information about the vehicles that were serviced at this service station. Example of technical information: list and dates of scheduled maintenance, brands of used motor oils, detected fault codes with further recommendations for vehicle repair, list of recommended spare parts for replacement, i.e. such information that may be useful in subsequent technical work with the vehicle

Previously, using the standard tool for working with domain names, such as the registrant panel 406, one must register an ENUM domain name 407 that corresponds to the phone number of the SIM card that is integrated into the vehicle 405. Thus, the telephone number subscriber in this case is a vehicle.

In the DNS zone of the ENUM domain, NAPTR resource records 408 are created using the DNS zone tools, such as the registrant panel 406. Each such record contains the service type “VEHICLE”, the service identifier, the reference 409 to the service registry 404 and the identifier of the telephone number subscriber in the service database. Each of these resource records 408 corresponds to a single technical organization, whose server 417 stores the relevant data, and which serves this vehicle. Thus, each service station is a service that provides available technical information about vehicles upon authorized request.

If there is a need to find out the service history of the vehicle, for example, when repairing a car in a different city 411, by knowing the phone number of the SIM card that is integrated into the car 405, the service station employee 412 using special software 413, queries 414 the DNS zone of the ENUM domain, finds all resource records containing the service type “VEHICLE” 408 there, obtains service identifiers and reference 409 to the service registry 404 from these records, accesses the service registry 404 and receives 415 metadata and Internet addresses of the service of the organization 417, which can be requested technical information about the vehicle, using the identifier of the telephone number subscriber (vehicle) in the databases of services, which are also contained in the ENUM resource records of domain 408.

Next, with the help of specialized software 413, authorized requests 416 are generated and technical information about the vehicle with an integrated SIM card is obtained.

Thus, access to technical information (which can be processed automatically), if necessary, is greatly facilitated, which reduces the likelihood of mistakes during vehicle maintenance.

Based on the above, the specialist must understand the solution of the problem and achievement of the stated technical result.

What is claimed is:

1. A method of identifying a service, comprising steps of:
forming a request for an information about the service,
wherein
pre-creating a service registry, in which by means of a first network tool pre-entering at least one entry that characterizes properties of the service, and the service registry is implemented with an ability to change, add and delete an entry that characterizes the properties of the service,
then by means of a second network tool, entering at least one resource record containing a type of the service, reference to the service registry, a service identifier in the registry, service parameters for further access to the registry of services to a DNS zone of an ENUM domain associated with a telephone number;
converting the phone number by a method defined for ENUM into an ENUM domain name,
then using a third network tool generating a DNS query to obtain resource records for said ENUM domain name using DNS tools,
at least one resource record associated with the specified ENUM domain name of the telephone number is sent from a DNS server to the third network tool in response to a DNS query,
obtaining from at least one resource record the information about the service identifier, the type of the service, the reference to the service registry, the service parameters for a further formation of a request to the service registry,
using the third network tool forming and performing a request to the service registry, which at a minimum contains the service identifier,
in response to the request to the service registry, an information about the network address and metadata of the service is sent to the third network tool from the service registry.
